(19) United States
(12) Patent Application Publication
(10) Pub. No.: US 2022/0255070 A1
(43) Pub. Date: Aug. 11, 2022

(54) SILICON ANODES WITH FUNCTIONAL COATINGS

(71) Applicant: Apple Inc., Cupertino, CA (US)

(72) Inventors: Kai Yan, Milpitas, CA (US); Tsuyonobu Hatazawa, Machida (JP)

(73) Assignee: Apple Inc., Cupertino, CA (US)

(21) Appl. No.: 17/665,905

(22) Filed: Feb. 7, 2022

Related U.S. Application Data
(60) Provisional application No. 63/147,162, filed on Feb. 8, 2021.

(51) Int. Cl. H01M 4/38

(52) U.S. Cl. CPC H01M 4/386; H01M 2004/021

(57) ABSTRACT

Battery cells according to embodiments of the present technology may include a cathode. The battery cells may include an anode including silicon particles. The silicon particles may be coated with a material physically and/or chemically bonding about the silicon particles to produce coated particles. The coated silicon particles may be formed into an electrode active material. The battery cells may include a separator disposed between the cathode and the anode. The battery cells may include an electrolyte.

### CROSS-REFERENCES TO RELATED APPLICATIONS

The present application claims the benefit of, and priority to, U.S. provisional application No. 63/147,162, filed Feb. 8, 2021, the contents of which are hereby incorporated by reference in their entirety for all purposes.

### TECHNICAL FIELD

The present technology relates to batteries. More specifically, the present technology relates to anode materials and coatings.

### BACKGROUND

Batteries are used in many devices. As increased energy densities are sought for a number of devices, improved designs are needed.

### SUMMARY

Battery cells according to embodiments of the present technology may include a cathode. The battery cells may include an anode including silicon particles. The silicon particles may be coated with a material physically and/or chemically bonding about the silicon particles to produce coated particles. The coated silicon particles may be formed into an electrode active material. The battery cells may include a separator disposed between the cathode and the anode. The battery cells may include an electrolyte.

In some embodiments, the material coating the silicon particles may be selected from the group including of a fluorinated polymer, a polythiophene, a parylene organic layer, or graphitic carbon nitride. The fluorinated polymer may include a fluorinated diol having a plurality of CF₂ moieties coupled between oxygen atoms. The fluorinated diol may include at least two CF₂ moieties between the oxygen atoms. The polythiophene may include an ethynyl group. The polythiophene may be or include 3-ethynylthiophene or 3,3′-dithiophene. The parylene organic layer may be or include a fluorinated parylene. The silicon particles may be or include silicon and carbon. The silicon particles may include an ion-conducting ceramic coating. The silicon particles may be characterized by an average particle diameter of less than or about 50 μm. The material coating the silicon particles may be characterized by a thickness of less than or about 50 nm.

Some embodiments of the present technology may encompass battery cells. The battery cells may include a cathode. The battery cells may include an anode including silicon particles. The silicon particles may be coated with a material physically or chemically bonding with the silicon particles to produce coated silicon particles. The coated silicon particles may be formed into an electrode active material. The battery cells may include a separator disposed between the cathode and the anode. The battery cells may include an electrolyte.

In some embodiments, the material coating the silicon particles may include a polyimide incorporating polyethylene oxide or polypropylene oxide. The material coating the silicon particles may be or include s-biphenyl dianhydride-p-phenylenediamine. The material coating the silicon particles may be or include 4,4′-oxydianiline or 4,4′-diaminodicyclohexylmethane. The material coating the silicon particles may be or include an oxygen coupling silane with a surface of the silicon particles. The material may be or include a monolayer of silane. The silane may include a vinyl or epoxy group coupled with the silicon. The silicon particles may be characterized by an average particle diameter of less than or about 50 μm. The material coating the silicon particles may be characterized by a thickness of less than or about 50 nm.

Such technology may provide numerous benefits over conventional technology. For example, the present battery cells may be characterized by increased Coulombic efficiency compared with conventional silicon anode configurations. Additionally, the battery cells may be characterized by improved cycle life by controlling side reactions between silicon and the electrolyte or additives. These and other embodiments, along with many of their advantages and features, are described in more detail in conjunction with the below description and attached figures.

### BRIEF DESCRIPTION OF THE DRAWINGS

A further understanding of the nature and advantages of the disclosed embodiments may be realized by reference to the remaining portions of the specification and the drawings.

FIG. 1 shows a schematic cross-sectional view of a battery cell according to some embodiments of the present technology.

FIG. 2 shows a schematic front elevation view of a battery according to some embodiments of the present technology.

FIGS. 3A-3B show exemplary anode particles according to some embodiments of the present technology.

Several of the figures are included as schematics. It is to be understood that the figures are for illustrative purposes, and are not to be considered of scale or proportion unless specifically stated to be of scale or proportion. Additionally, as schematics, the figures are provided to aid comprehension and may not include all aspects or information compared to realistic representations, and may include exaggerated material for illustrative purposes.

In the figures, similar components and/or features may have the same numerical reference label. Further, various components of the same type may be distinguished by following the reference label by a letter that distinguishes among the similar components and/or features. If only the first numerical reference label is used in the specification, the description is applicable to any one of the similar components and/or features having the same first numerical reference label irrespective of the letter suffix.

### DETAILED DESCRIPTION

Batteries, battery cells, and more generally energy storage devices, are used in a host of different systems. In many devices, the battery cells may be designed with a balance of characteristics in mind. For example, including larger batteries may provide increased usage between charges, however, the larger batteries may require larger housing, or increased space within the device. As device designs and configurations change, especially in efforts to reduce device sizes, the available space for batteries may be constrained. Accordingly, efforts have sought to produce rechargeable batteries with materials characterized by increased energy density.

Many conventional rechargeable batteries utilize a graphite anode material. Although the material cycles effectively, graphite is characterized by a relatively low energy density that limits further energy density scaling. Efforts have been undertaken to produce anode materials utilizing silicon, which has a theoretical capacity of more than an order of magnitude higher than graphite. However, conventional silicon anodes are characterized by a number of drawbacks that limit more effective usage. For example, based on the silicon organization in the anode, lithium intercalation and removal causes extensive expansion of the structure, which causes increased loss over time due to the weakening or cracking of the anode structure. Additionally, silicon interactions with the electrolyte and solvents included in the electrolyte can cause a number of side reactions that can limit effective operation. Consequently, use of silicon in anode materials has been limited.

The present technology overcomes these technological challenges by forming functional coatings around the incorporated silicon particles of the anode, instead of simply the anode structure as a whole. By forming particular coatings about the particles, a number of benefits may be afforded including increased operational efficiency and cycle life. Accordingly, the functionally coated silicon particle anodes of the present technology may provide improved reliability over conventional designs. Although the remaining portions of the description will reference lithium-ion batteries, it will be readily understood by the skilled artisan that the technology is not so limited. The present techniques may be employed with any number of battery or energy storage devices, including other rechargeable and primary battery types, as well as secondary batteries, or electrochemical capacitors. Moreover, the present technology may be applicable to batteries and energy storage devices used in any number of technologies that may include, without limitation, phones and mobile devices, watches, glasses, bracelets, anklets, and other wearable technology including fitness devices, handheld electronic devices, laptops and other computers, as well as other devices that may benefit from the use of the variously described battery technology.

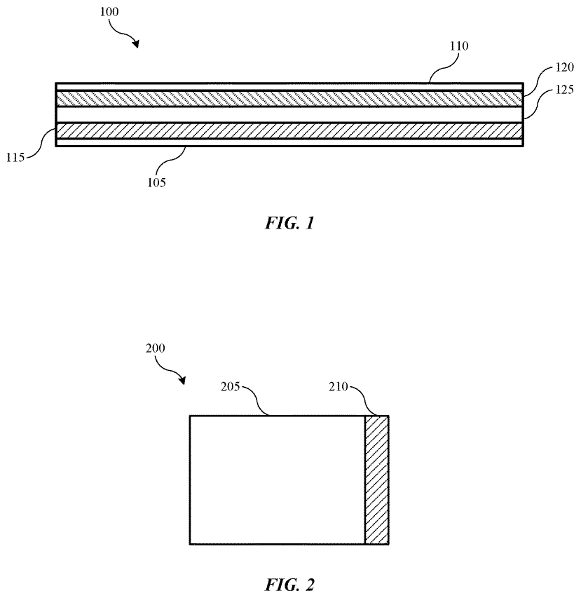

FIG. 1 depicts a schematic cross-sectional view of an energy storage device or battery cell 100 according to embodiments of the present technology. Battery cell 100 may be or include a battery cell, and may be one of a number of cells coupled together to form a battery structure. As would be readily understood, the layers are not shown at any particular scale, and are intended merely to show the possible layers of cell material of one or more cells that may be incorporated into an energy storage device. In some embodiments, as shown in FIG. 1, battery cell 100 includes a first current collector 105 and a second current collector 110. In embodiments one or both of the current collectors may include a metal or a non-metal material, such as a polymer or composite that may include a conductive material. The first current collector 105 and second current collector 110 may be different materials in embodiments. For example, in some embodiments the first current collector 105 may be a material selected based on the potential of an anode active material 115, and may be or include copper, stainless steel, or any other suitable metal, as well as a non-metal material including a polymer. The second current collector 110 may be a material selected based on the potential of a cathode active material 120, and may be or include aluminum, stainless steel, or other suitable metals, as well as a non-metal material including a polymer. In other words, the materials for the first and second current collectors can be selected based on electrochemical compatibility with the anode and cathode active materials used, and may be any material known to be compatible.

In some instances the metals or non-metals used in the first and second current collectors may be the same or different. The materials selected for the anode and cathode active materials may be any suitable battery materials operable in rechargeable as well as primary battery designs. For example, the anode active material 115 may be or include any of silicon, silicon oxide, silicon-carbon combinations, silicon alloy, graphite, carbon, a tin alloy, lithium metal, a lithium-containing material, such as lithium titanium oxide (LTO), a combination of any of these materials, or other suitable materials that can form an anode in a battery cell. Additionally, for example, the cathode active material 120 may be a lithium-containing material. In some embodiments, the lithium-containing material may be a lithium metal oxide, such as lithium cobalt oxide, lithium manganese oxide, lithium nickel manganese cobalt oxide, lithium nickel cobalt aluminum oxide, lithium nickel cobalt manganese oxide, lithium nickel cobalt aluminum oxide, lithium titanate, or a combination of any of these materials, while in other embodiments the lithium-containing material can be a lithium iron phosphate, or other suitable materials that can form a cathode in a battery cell.

The first and second current collectors as well as the active materials may have any suitable thickness. A separator 125 may be disposed between the electrodes, and may be a polymer film, a ceramic membrane, or a material that may allow lithium ions to pass through the structure while not otherwise conducting electricity. Active materials 115 and 120 may additionally include an amount of electrolyte in a completed cell configuration, which may be absorbed within the separator 125 as well. The electrolyte may be a liquid including one or more salt compounds that have been dissolved in one or more solvents. The salt compounds may include lithium-containing salt compounds in embodiments, and may include one or more lithium salts including, for example, lithium compounds incorporating one or more halogen elements such as fluorine or chlorine, as well as other non-metal elements such as phosphorus, and semimetal elements including boron, for example.

In some embodiments, the salts may include any lithium-containing material that may be soluble in organic solvents. The solvents included with the lithium-containing salt may be organic solvents, and may include one or more carbonates. For example, the solvents may include one or more carbonates including propylene carbonate, ethylene carbonate, ethyl methyl carbonate, dimethyl carbonate, diethyl carbonate, and fluoroethylene carbonate. Combinations of solvents may be included, and may include for example, propylene carbonate and ethyl methyl carbonate as an exemplary combination. Any other solvent may be included that may enable dissolving the lithium-containing salt or salts as well as other electrolyte component, for example, or may provide useful ionic conductivities, such as greater than or about 5⁻¹⁰ mS/cm.

Although illustrated as single layers of electrode material, battery cell 100 may be any number of layers. Although the cell may be composed of one layer each of anode and cathode material as sheets, the layers may also be formed into a jelly roll design, or folded design, prismatic design, or any form such that any number of layers may be included in battery cell 100. For embodiments which include multiple layers, tab portions of each anode current collector may be coupled together, as may be tab portions of each cathode current collector. Once the cell has been formed, a pouch, housing, or enclosure may be formed about the cell to contain electrolyte and other materials within the cell structure, as will be described below. Terminals may extend from or be coupled with the enclosure to allow electrical coupling of the cell for use in devices, including an anode and cathode terminal. The coupling may be directly connected with a load that may utilize the power, and in some embodiments the battery cell may be coupled with a control module that may monitor and control charging and discharging of the battery cell. FIG. 1 is included as an exemplary cell that may be incorporated in batteries according to the present technology. It is to be understood, however, that any number of battery and battery cell designs and materials that may include charging and discharging capabilities similarly may be encompassed by or incorporated with the present technology.

FIG. 2 shows a schematic plan view of a battery system 200 according to some embodiments of the present technology. As illustrated, battery system 200 may include a battery cell or battery 205, which may include any number of battery cells, as well as a battery module 210. Battery module 210 may be electrically connected with battery 205 to provide a variety of functionality. For example, battery module 210 may monitor battery 205 during charging and discharging operations, and may ensure the battery is not overcharged or over-depleted during use. Additionally, battery module 210 may monitor overall health of the battery 205 to ensure proper functioning. Battery module 210 may couple with terminals of the battery, such as one or both of the positive and negative terminals, in order to provide this functionality.

Battery module 210 may also include an additional electrical connector, such as a coupling, that may allow device components to access the battery capacity through the battery module 210. In this way, battery module 210 may provide a pass-through functionality for delivering power from battery 205. Consequently, battery module 210 may be under constant load from the battery. Battery 205 may include a battery cell, which may be similar to battery cell 100 described above, and may include a pouch or enclosure to protect the battery cell from exposure to the environment. The housing may also operate to maintain electrolyte and other materials within the battery cell. To access the battery cell through this housing, one or more terminals or leads may extend through the housing.

Some conventional designs may wrap the battery module 210 onto the terminals of battery 205, which may allow the provision of additional materials to protect terminals and conductive components from fluid contact. However, as device configurations continue to shrink, battery designs change, and manufacturing processes incorporate many more small scale operations with smaller and/or thinner materials, these types of incorporations may become less feasible or prone to causing damage. The present technology allows for an adjacent coupling of the battery module 210 onto terminals of the battery 205, which may further reduce the overall battery system envelope when incorporated within an electronic device.

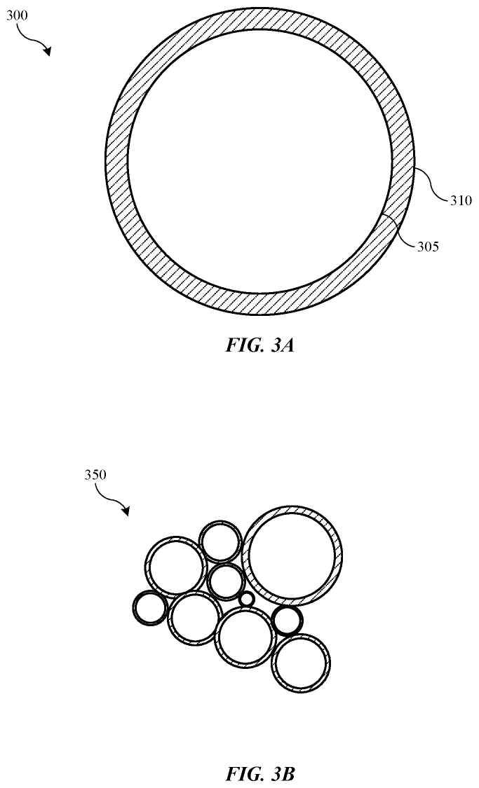

Turning to FIGS. 3A-3B is illustrated particles according to some embodiments of the present technology. Illustrated in FIG. 3A is an exemplary anode particle according to some embodiments of the present technology. As illustrated, the silicon core particle 305 may include an outer coating 310 about the particle. The coatings may be physically and/or chemically bonded with the silicon particle core, and may include a number of specific materials that facilitate improved operational performance. The coatings may produce specific interactions with electrolyte or solvent materials within the cell, or may facilitate aspects of a solid-electrolyte interface layer to protect the silicon particles. Coatings may be used in any combination, including combinations incorporating an organic coating with an inorganic coating as either an interior or exterior layer, as well as a layer encompassing a formed active material or electrode.

Once the particles are coated, an electrode active material 350 may be produced, as illustrated in FIG. 3B, where the coated particles may be agglomerated or compressed with any number of binders, and electrolyte materials. By utilizing coatings according to some embodiments of the present technology, improved cycle life for cells including silicon anode materials may be afforded. Silicon particles according to some embodiments of the present technology may be characterized by an average particle diameter that may be less than or about 50 μm, and in some embodiments may be less than or about 40 μm, less than or about 30 μm, less than or about 20 μm, less than or about 15 μm, less than or about 12 μm, less than or about 10 μm, less than or about 9 μm, less than or about 8 μm, less than or about 7 μm, less than or about 6 μm, less than or about 5 μm, less than or about 4 μm, less than or about 3 μm, less than or about 2 μm, less than or about 1 μm, or less. The particles may consist of silicon in some embodiments, and in some embodiments the particles may include silicon and carbon. Coatings on the particles may include a primary coating in some embodiments, which may include a ceramic or any other coating material in some embodiments.

Coatings according to some embodiments of the present technology may include coatings having fluorine and/or oxygen within the coating molecules, and may include a fluorinated polymer. Materials incorporating fluorine and oxygen may be fabricated to produce a shell about the silicon, and the fluorine and oxygen incorporation may be utilized to facilitate lithium coordination during operation. Any number of polymeric materials may be used to produce a base for use with a fluorine-containing material. For example, in some embodiments a fluorinated diol may be utilized with a one or more materials to produce a polymeric material, which may produce a shell about the silicon to provide a number of qualities, or simplify the synthesis. For example, a diisocyanate may be combined with a fluorinated alcohol to produce a fluorinated polyurethane. In some embodiments the coating may include a diisocyanate and a fluorinated alcohol in a 1:1 molar ratio in the produced coating.

The material may include diethyltoluenediamine or other amine-containing materials formulated with a diisocyanate, such as hexamethylene diisocyanate as one non-liming example.

This may produce an elastomeric backbone, which may form about the silicon particles and limit side reactions with the electrolyte or solvent materials. The fluorinated alcohol may be a fluoroalcohol or any other organofluorine compound including one or more CF units. The fluorinated alcohol may include one or more CF₂ or CF₃ moieties in the coating produced, along with an alcohol or other oxygen-containing material. The fluorinated alcohol may be a partially fluorinated alcohol incorporating a plurality of CF₂ units, such as (CF₂)ₙ units formed within a carbon chain including oxygen. In some embodiments N may be or include a number of CF₂ nodes formed between oxygen atoms within the chain, for example, and N may be or include greater than or about 1, greater than or about 2, greater than or about 3, greater than or about 4, greater than or about 5, greater than or about 6, greater than or about 7, greater than or about 8, or more CF₂ units in some embodiments of the present technology.

One advantage of the coating may include that the fluorine incorporation may aid in repulsion of solvents and electrolyte additives from the surface of the silicon particles, and side reactions may be reduced. The coating may be sized to ensure a continuous coverage is afforded, and in some embodiments may be greater than or about 4 nm, and may be greater than or about 5 nm, greater than or about 10 nm, greater than or about 15 nm, greater than or about 20 nm, greater than or about 25 nm, greater than or about 30 nm, greater than or about 35 nm, greater than or about 40 nm, greater than or about 45 nm, or more. However, as the coating increases in thickness, the available volume of the active material for silicon may be reduced, which may affect energy density of the formed battery cell, and may negatively impact electrical connections between the particles or the electrode. Consequently, the coating may be maintained at a thickness of less than or about 40 nm, and may be maintained at a thickness of less than or about 35 nm, less than or about 30 nm, or less.

Some embodiments of the present technology may incorporate a sulfur-containing coating about the particles. Similar to oxygen, sulfur may impart a weaker coordination of functional groups that can benefit operation of the silicon as well as the cell in general. For example, the sulfur and oxygen can aid lithium cation desolvation from solvents at the solid-electrolyte interface during operation. Consequently, the solvent may be released more readily, which can help avoid or prevent interaction with the silicon surface that may be reactive and cause side reaction or byproducts.

Any number of sulfur-containing materials may be used, including polythiophenes, which may provide beneficial operational efficiencies over other materials. For example, exemplary materials used to produce coatings about the silicon particles may be or include 3,4-ethylenedioxythiophene, 3-hexylthiophene, 3-phenylthiophene, 3-ethynylthiophene, 3,3′-dithiophene, benzo[1,2-b:4,5-b′]dithiophene-4,8-dione, among any other thiophene, or sulfur-containing materials. Materials incorporating an additional hydrocarbon chain and/or additional thiophene moieties may impart improved operation and cycling efficiency by enhancing the formation of the solid-electrolyte interface on the silicon surface as compared to other materials that may impact electrode expansion or other aspects. Accordingly, in some embodiments the coating may include 3-hexylthiophene, 3-ethynylthiophene, or 3,3′-dithiophene, as examples of thiophene materials due to these additional benefits.

Some embodiments of the present technology may incorporate a parylene coating about the particles. The compact benzene structure of parylenes may produce a more restrictive physical barrier protecting the silicon particles from negative interactions with electrolyte additives. For example, the parylene may include any material characterized by a number of para-benzenediyl rings. The parylene may include any number of incorporated functional groups replacing hydrogen atoms on the structure, although in some embodiments the parylene may be or include parylene-n or the non-substituted parylene. Substitutions in the parylene may include any number of materials including halogen materials, alkyl units, or reactive groups that may interact with materials in the electrolyte.

As one non-limiting example, a fluorinated parylene may be utilized incorporating fluorine either within a functional group as a replacement of a hydrogen on the para-benzenediyl rings or along the aliphatic chain of the unit. For example, the repeating units of the fluorinated parylene may include 1, 2, 3, 4, 5, 6, or more fluorine atoms incorporated within the structure, which may impart repulsive benefits as noted previously. The parylene may be incorporated alone or as a combination layer with an additional organic or inorganic coating layer. By operating as a physical passivation layer about the silicon particles, the material may operate to reduce or limit direct contact between the electrolyte molecules and the surface of the silicon particles.

In some embodiments, the coating may be or include a packed graphitic carbon nitride layer. Similar to the parylene coating, the graphitic material may produce a layered structure about the silicon particles, which may limit exposure of the silicon to electrolyte and may be inert to most additives within the electrolyte. The graphitic carbon nitride may be produced with any number of precursors. Exemplary precursors may be or include guanidine carbonate, cyanuric acid, melamine, or any number of other materials. Because of the denser packing of layers of graphitic carbon nitride, in some embodiments a thinner coating may be produced, and the coating may be less than or about 30 nm, less than or about 25 nm, less than or about 20 nm, less than or about 15 nm, less than or about 10 nm, less than or about 5 nm, less than or about 1 nm, or less. However, the layer may be maintained greater than or about 1 nm to ensure more complete coverage about the silicon particles.

Some embodiments of the present technology may also produce a chemically-bonded coating about the silicon particles, which may be utilized in addition to or as an alternative to any of the previously noted materials. For example, in some embodiments an oxygen-containing or sulfur-containing material may be chemically bonded with the silicon particulate material to provide similar effects as stated previously for coordinating with lithium cations nearer to the surface of the silicon particles, which again may reduce exposure of the silicon to electrolyte molecules. By chemically bonding with the surface of the particles, some coating thicknesses may be further reduced compared to some physically-bonded materials, although any coating may be characterized by any of the thicknesses as previously described for coating particles characterized by any of the average diameters noted above.

An exemplary material that may be incorporated as a coating about the silicon particles may be a functionalized polyimide material, or other plastic material that may operate effectively in a cell environment where cycling may generate heat that can negatively affect other polymeric coatings. As one non-limiting example, the polyimide coating may include polyethylene oxide or polypropylene oxide as a unit within the structure. Similarly to materials discussed above, polyethylene oxide or polypropylene oxide may operate as a weak coordinating functional group facilitating release of solvents from the solid-electrolyte interface and limiting interaction with the silicon particles.

Exemplary polyimides may include any number of materials and may specifically include polyethylene oxide and/or polypropylene oxide in embodiments of the present technology. The polyimide may be aliphatic, semi-aromatic, or aromatic in embodiments. The monomers may be any polyimide-generating materials, and may include a diamine or a diisocyanate reaction with dianhydride. As one non-limiting example, a monomer may be or include biphenyl-tetracarboxylic acid dianhydride and may produce a polyimide including s-biphenyl dianhydride-p-phenylenediamine. Incorporated within the material may be polyethylene oxide and/or polypropylene oxide along with any number of additional materials. As non-limiting examples, the coatings may include 4,4′-diaminodicyclohexylmethane, and may include 4,4′-oxydianiline.

The materials may include any number of combinations of these materials to produce coatings according to some embodiments of the present technology. For example, coatings about silicon particles may include polyethylene oxide/(biphenyl dianhydride-p-phenylenediamine) polyimide, polyethylene oxide/4,4′-oxydianiline/(biphenyl dianhydride-p-phenylenediamine) polyimide, polyethylene oxide/4,4′-diaminodicyclohexylmethane/(biphenyl dianhydride-p-phenylenediamine) polyimide, polypropylene oxide/(biphenyl dianhydride-p-phenylenediamine) polyimide, polypropylene oxide/4,4′-oxydianiline/(biphenyl dianhydride-p-phenylenediamine) polyimide, polypropylene oxide/4,4′-diaminodicyclohexylmethane/(biphenyl dianhydride-p-phenylenediamine) polyimide, polyethylene oxide/polypropylene oxide/(biphenyl dianhydride-p-phenylenediamine) polyimide, polyethylene oxide/polypropylene oxide/4,4′-oxydianiline/(biphenyl dianhydride-p-phenylenediamine) polyimide, polyethylene oxide/polypropylene oxide/4,4′-diaminodicyclohexylmethane/(biphenyl dianhydride-p-phenylenediamine) polyimide, among other combinations.

Some embodiments of the present technology may also include silane as a coupling agent with the surface of the silicon materials. For example, an oxygen may bond the silicon from silane with the surface of the silicon particles providing benefits as previously described, and which may then produce a monolayer, including a self-assembled monolayer of silicon-containing materials about the silicon particles. The silane agent may be incorporated with a solvent for producing the coating, and non-limiting silane agents may be or include 3-glycidoxypropyl trimethoxysilane, vinyl trimethoxysilane, or 3-(methacryloyloxy)propyl trimethoxysilane. Halogenated silane agents including fluorinated agents may be included such as (1H,1H,2H,2H-perfluorooctyl)dimethylchlorosilane, among any other halogenated or fluorinated silane agents, which may provide similar benefits as fluorine-containing materials previously described. The silane monolayer may include any number of functional groups extending from the silicon coating. For example, vinyl, epoxy, and other functional groups may facilitate or participate in formation of the solid-electrolyte interface. Without being bound to any particular theory, vinyl and epoxy groups may provide anchoring locations for the solid-electrolyte interface, and may further reduce or limit interactions between the electrolyte and the silicon of the silicon particles.

By utilizing materials and coatings according to embodiments of the present technology, improved cycle life and Coulombic efficiency may be afforded. For example, materials according to the present technology may limit anode losses each cycle improving Coulombic efficiency. Materials according to the present technology may be characterized by a Coulombic efficiency of greater than or about 99.94%, and may be characterized by a Coulombic efficiency of greater than or about 99.95%, greater than or about 99.96%, greater than or about 99.97%, greater than or about 99.98%, greater than or about 99.99%, or greater. This may afford an estimated cycle life of greater than or about 200 cycles, and may afford an estimated cycle life of greater than or about 300 cycles, greater than or about 400 cycles, greater than or about 500 cycles, greater than or about 600 cycles, greater than or about 700 cycles, greater than or about 800 cycles, greater than or about 900 cycles, greater than or about 1000 cycles, or more. These performance enhancements over conventional technologies may afford improved device life and energy density.

In the preceding description, for the purposes of explanation, numerous details have been set forth in order to provide an understanding of various embodiments of the present technology. It will be apparent to one skilled in the art, however, that certain embodiments may be practiced without some of these details, or with additional details.

Having disclosed several embodiments, it will be recognized by those of skill in the art that various modifications, alternative constructions, and equivalents may be used without departing from the spirit of the embodiments. Additionally, a number of well-known processes and elements have not been described in order to avoid unnecessarily obscuring the present technology. Accordingly, the above description should not be taken as limiting the scope of the technology.

Where a range of values is provided, it is understood that each intervening value, to the smallest fraction of the unit of the lower limit, unless the context clearly dictates otherwise, between the upper and lower limits of that range is also specifically disclosed. Any narrower range between any stated values or unstated intervening values in a stated range and any other stated or intervening value in that stated range is encompassed. The upper and lower limits of those smaller ranges may independently be included or excluded in the range, and each range where either, neither, or both limits are included in the smaller ranges is also encompassed within the technology, subject to any specifically excluded limit in the stated range. Where the stated range includes one or both of the limits, ranges excluding either or both of those included limits are also included. Where multiple values are provided in a list, any range encompassing or based on any of those values is similarly specifically disclosed.

As used herein and in the appended claims, the singular forms “a”, “an”, and “the” include plural references unless the context clearly dictates otherwise. Thus, for example, reference to “a material” includes a plurality of such materials, and reference to “the cell” includes reference to one or more cells and equivalents thereof known to those skilled in the art, and so forth.

Also, the words “comprise(s)”, “comprising”, “contain(s)”, “containing”, “include(s)”, and “including”, when used in this specification and in the following claims, are intended to specify the presence of stated features, integers, components, or operations, but they do not preclude the presence or addition of one or more other features, integers, components, operations, acts, or groups.

What is claimed is:

1. A battery cell comprising:
a cathode;
an anode comprising silicon particles, wherein the silicon particles are coated with a material bonding about the silicon particles to produce coated silicon particles, and wherein the coated silicon particles are formed into an electrode active material;
a separator disposed between the cathode and the anode; and
an electrolyte.

2. The battery cell of claim 1, wherein the material coating the silicon particles is selected from the group consisting of a fluorinated polymer, a polythiophene, a parylene organic layer, and graphitic carbon nitride.

3. The battery cell of claim 2, wherein the fluorinated polymer comprises a fluorinated diol having a plurality of CF₂ moieties coupled between oxygen atoms.

4. The battery cell of claim 3, wherein the fluorinated diol comprises at least two CF₂ moieties between the oxygen atoms.

5. The battery cell of claim 2, wherein the polythiophene comprises an ethynyl group.

6. The battery cell of claim 5, wherein the polythiophene comprises 3-ethynylthiophene or 3,3′-dithiophene.

7. The battery cell of claim 2, wherein the parylene organic layer comprises a fluorinated parylene.

8. The battery cell of claim 1, wherein the silicon particles comprise silicon and carbon.

9. The battery cell of claim 1, wherein the silicon particles comprises an ion-conducting ceramic coating.

10. The battery cell of claim 1, wherein the silicon particles are characterized by an average particle diameter of less than or about 50 μm.

11. The battery cell of claim 10, wherein the material coating the silicon particles is characterized by a thickness of less than or about 50 nm.

12. A battery cell comprising:
a cathode;
an anode comprising silicon particles, wherein the silicon particles are coated with a material physically or chemically bonding with the silicon particles to produce coated silicon particles, and wherein the coated silicon particles are formed into an electrode active material;
a separator disposed between the cathode and the anode; and
an electrolyte.

13. The battery cell of claim 12, wherein the material coating the silicon particles comprises a polyimide incorporating polyethylene oxide or polypropylene oxide.

14. The battery cell of claim 13, wherein the material coating the silicon particles comprises s-biphenyl dianhydride-p-phenylenediamine.

15. The battery cell of claim 14, wherein the material coating the silicon particles comprises 4,4′-Oxydianiline or 4,4′-diaminodicyclohexylmethane.

16. The battery cell of claim 12, wherein the material coating the silicon particles comprises an oxygen coupling silane with a surface of the silicon particles.

17. The battery cell of claim 16, wherein the material comprises a monolayer of silane.

18. The battery cell of claim 16, wherein the silane comprises a vinyl or epoxy group coupled with the silicon.

19. The battery cell of claim 12, wherein the silicon particles are characterized by an average particle diameter of less than or about 50 μm.

20. The battery cell of claim 12, wherein the material coating the silicon particles is characterized by a thickness of less than or about 50 nm.
